(19) United States
(12) Patent Application Publication
(10) Pub. No.: US 2013/0226830 A1
(43) Pub. Date: Aug. 29, 2013

(54) SYSTEM AND METHOD FOR TRANSACTIONAL RISK AND RETURN ANALYSIS

(71) Applicants: Kete Long, Niskayuna, NY (US); Colin Craig McCulloch, Charlton, NY (US); Sean Coleman Keenan, Norwalk, CT (US)

(72) Inventors: Kete Long, Niskayuna, NY (US); Colin Craig McCulloch, Charlton, NY (US); Sean Coleman Keenan, Norwalk, CT (US)

(73) Assignee: General Electric Company, Schenectady, NY (US)

(21) Appl. No.: 13/407,623

(22) Filed: Feb. 28, 2012

(51) Int. Cl. G06Q 40/06

(52) U.S. Cl. 705/36 R

(57) ABSTRACT

Transactional risk and return analysis systems provided herein include a transaction database and a market database. The transaction database includes data regarding transactions with associated attributes and the market database includes market data. A portfolio model uses such data to estimate a risk prediction for each transaction. A risk prediction model is generated based on the portfolio model and estimates a risk prediction for a prospective transaction, and a case cash flow analyzer produces a risk-breakeven spread. A transaction evaluator uses the risk prediction model and the risk-breakeven spread to calculated transaction risk and return data for a prospective transaction.

### BACKGROUND

In financial contexts, a typical loan transaction may relate to the extension of a loan or credit by one party to another. In such a context, various rewards and risks attach to the different parties to the transaction. For example, a risk to the party writing the loan is the risk of default, either partial or complete, on the loan. Conversely, the reward to the party writing the loan would typically be in the form of a monetary return on money loaned. Similarly, from the perspective of the party receiving the loan, the reward may be the availability of money or financing that can then be used to generate additional funds, such as through the course of business or by investment of the borrowed money.

A party that generates a large number of loans may effectively hold or maintain a large portfolio of such positions. Such a party may engage in various activities to monitor and manage the various risks that are associated with holding such a portfolio of loans (or other financial instruments). Such risks may include, among others, lack of diversification among the loans or other instruments held. Such lack of diversification may take a number of forms, such as lack of geographic diversification, lack of diversification based on the types of businesses involved, lack of diversification with respect to the size of the loans or of the borrowers, and so forth. Further, the respective risks associated with individual loans or a portfolio of such loans may vary based on the existing and/or projected company ratings, terms of the transaction, capital costs or availability, and/or general market conditions (e.g., employment rate, inflation, monetary and fiscal policies, stock market trends, and so forth).

As a result, evaluating a portfolio of financial instruments, such as loans, may prove to be a difficult both due to the number of factors that may be considered as well as due to the interrelationships among these factors. These difficulties may manifest themselves in other ways as well. In particular, the number of factors that may affect an assessment of a portfolio and interrelationships among these factors may also make it difficult to assess new additions to the portfolio. That is, evaluating the risk and return characteristics for a potential or prospective transaction with respect to an existing portfolio may prove to be difficult as well.

In the course of business, a portfolio holder may accumulate records of previous transactions (i.e., historical data) and/or may have access to current information about the risk and value associated with the holdings of a portfolio. Based on such existing or prior portfolio holdings and information about such holdings, an entity may develop and maintain various types of portfolio models providing different types of data related to current and prior transactions and holdings. However, the portfolio models may be cumbersome and may not be quickly or easily used in evaluating prospective transactions. For example, a portfolio of half a million transactions may take hours or even days to analyze using conventional portfolio models and approaches, making such a portfolio unsuitable for rapid evaluation or analysis or prospective transactions.

### BRIEF DESCRIPTION

In one embodiment, a transactional risk and return analysis system includes a transaction database which includes data regarding transactions and associated attributes, and a market database which includes data regarding historical or current market conditions. The transactional risk and return analysis system also includes a portfolio model which may use data regarding each transaction in the transaction database and market data from the market database to estimate a risk prediction for each transaction. Further, a risk prediction model is generated based on outputs from the portfolio model and used to estimate a risk prediction for a prospective transaction. The transactional risk and return analysis system may also include a cash flow analyzer to calculate a risk-breakeven spread and a transaction evaluator to calculate transactional risk and return data from the risk prediction model and the risk-breakeven spread, in which a prospective transaction is applied to the risk prediction model.

In another embodiment, a transactional risk and return analysis tool includes a risk prediction model fitted from a portfolio model through regression modeling. The risk prediction model takes as an input, a prospective transaction and its associated attributes, and calculates a risk prediction for the prospective transaction. The transactional risk and return analysis tool may also include a cash flow analysis model and a risk and return evaluator. The cash flow analysis model provides a risk-breakeven spread for a prospective transaction, and the risk and return evaluator uses the risk prediction model, the cash flow analysis model, and the prospective transaction to output a transactional risk and return profile or a transaction evaluation report for the prospective transaction.

In another embodiment, a transactional risk and return analysis method includes inputting attributes of transactions from a transaction database and market data from a market database into a portfolio model, and estimating a risk prediction for each transaction using the portfolio model, in which the portfolio model outputs each transaction from the transaction database with its associated attributes, market conditions, and estimated risk prediction. The transactional risk and return analysis method also includes generating a regression model based on the output of the portfolio model, generating one or more risk measures for a prospective transaction using the regression model, generating a risk-breakeven spread for the proposed transaction using a case flow model, and evaluating a transactional risk and return based on the one or more risk measures and risk-breakeven spread. Such steps of the transactional risk and return analysis method are performed by a computing device based on programmed instructions.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an embodiment of a computing device in accordance with aspects of the present disclosure;

FIG. 2 illustrates, via diagram, an embodiment of a transactional risk and return analysis system, in accordance with aspects of the present disclosure;

FIG. 3 illustrates an embodiment of a flow chart of a transactional risk and return analysis program, in accordance with aspects of the present disclosure;

FIG. 4 illustrates an embodiment of a transactional risk and return system, in accordance with aspects of the present disclosure; and

FIG. 5 illustrates an embodiment of a graphical user interface of a transactional risk and return analysis tool, in accordance with aspects of the present disclosure.

### DETAILED DESCRIPTION

As discussed herein, the present approach provides, in certain embodiments, for the construction and fitting of a model that may be used in the evaluation of prospective transactions or to evaluate existing transactions. For example, in one such implementation, the model may be used to generate a report that may be used to evaluate a transaction (such as a prospective loan) and/or to generate a risk and return profile of a current or prospective transaction. As discussed herein, the present approach is implemented so as to provide rapid feedback (e.g., near instantaneous) with respect to a proposed transaction.

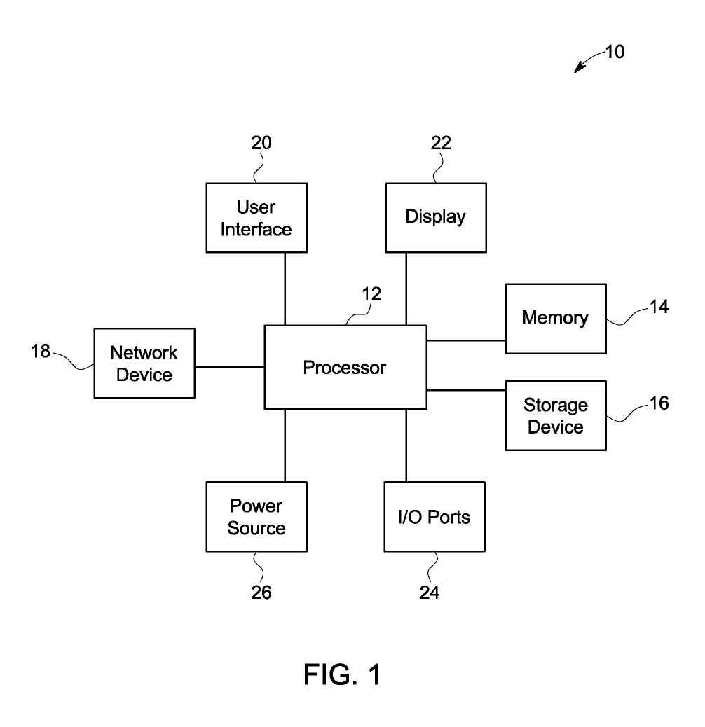

With the foregoing in mind, FIG. 1 is a diagrammatical representation of an embodiment of a computing device 10 (e.g., a processor-based system) suitable for implementing algorithms or routines embodying aspects of the present disclosure. For example, the embodied computing device 10 includes a processor 12, a memory 14, a storage device 16, a network device 18, a user interface 20, a display 22, one or more I/O ports 24, and a power supply 26. The processor 12 may provide data processing capability and/or program code execution capability consistent with the operation of the computing device 10, such as to perform computations related to transactional risk and return analysis, as discussed herein. Instructions and data to be processed by the processor 12 may be stored in the memory 14 or the storage device 16. The memory 14 may be provided as a volatile memory, such as random access memory (RAM), and/or as a non-volatile memory, such as read-only memory (ROM). The memory 14 may store a variety of information such as data to be analyzed (as discussed herein) as well as preprogrammed instructions for processing or handling such data. The storage device 16 may also store data and/or preprogrammed instructions. The storage device 16 may include flash memory, a hard drive, solid-state storage media, and so forth.

The network device 18 enables the computing device 10 to connect to a network such as the Internet or an intranet. For example, the network device 18 may allow the computing device 10 to communicate over a network, such as a Local Area Network (LAN), Wide Area Network (WAN), cellular network, or the Internet. The network device 18 may be a wired or wireless Network Interfacing Card (NIC) providing connectivity using a suitable networking protocol. Further, the computing device 10 may connect to and send or receive data or program code with any device on the network, such as portable electronic devices, personal computers, printers, and so forth. Alternatively, in some embodiments, the electronic device 10 may not include a network device 18.

The user interface 20 may include the various devices, circuitry, and pathways by which input or feedback is provided to the processor 16 by a user. For example, the user interface 20 may include buttons, sliders, switches, control pads, keys, knobs, scroll wheels, keyboards, mice, touchpads, and so forth.

The display 22 of the computing device 10 may be used to display various images and other visual outputs from the computing device 10 (such as a transaction evaluation report or a risk and return profile, as discussed herein) and/or a graphical user interface (GUI) that allows the user to interact with the computing device 10. The display 22 may be any type of display such as a cathode ray tube (CRT), a liquid crystal display (LCD), a light emitting diode (LED) display, an organic light emitting diode (OLED) display, or other suitable display. In certain embodiments, the display 22 and the user interface 20 may be implemented on the same structure, wherein the display 22 may includes a touch-sensitive element, acting as an input as well, such as in a touch screen.

The I/O ports 24 may include ports configured to connect to a variety of external devices, such as other electronic devices (such as handheld devices and/or computers, printers, projectors, external displays, modems, docking stations, and so forth). The I/O ports 24 may support any standard or proprietary interface type, such as a universal serial bus (USB) port, a video port, a serial connection port, an IEEE-1394 port, an Ethernet or modem port, and/or an AC/DC power connection port.

The power supply 26 may be configured to receive AC power, such as that provided by an electrical outlet. In certain embodiments, the power supply 26 may include one or more batteries, such as a lithium-ion polymer battery.

As will be appreciated, the various functional blocks shown in FIG. 1 and as described may include hardware elements (including application specific or generic circuitry), software elements (including computer code stored on a machine-readable medium) or a combination of both hardware and software elements. It should further be noted that FIG. 1 is merely one example of a particular embodiment and is merely intended to illustrate the types of components that may be present in the computing device 10. Certain embodiments of the computing device 10 may include more or fewer elements than those illustrated in the present embodiment.

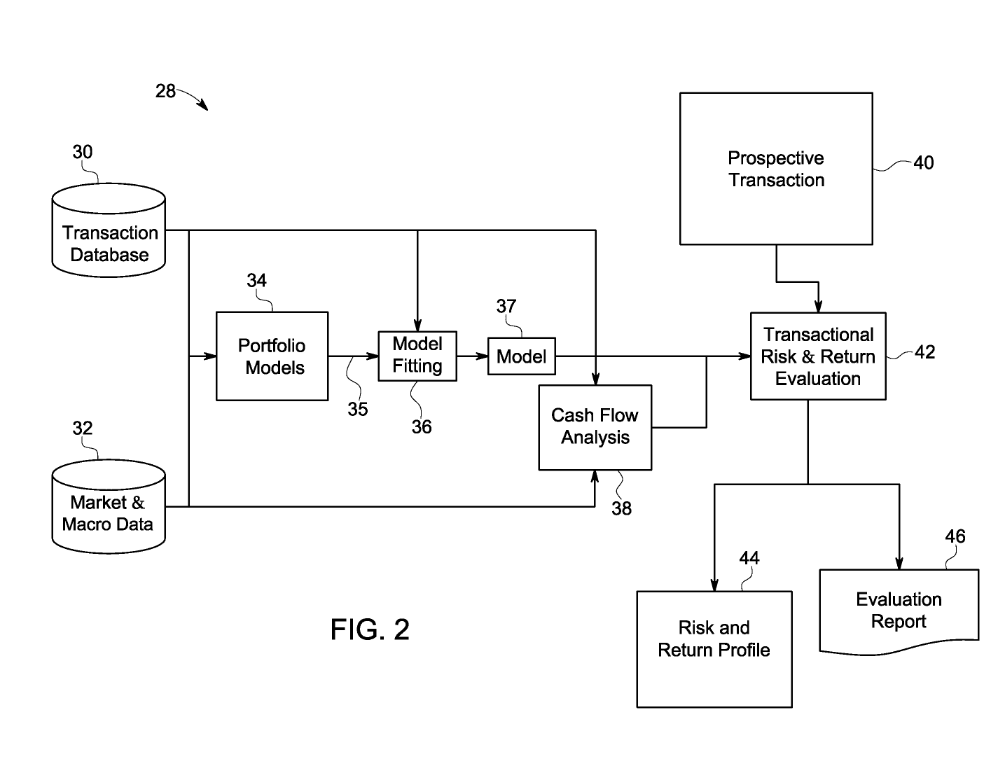

FIG. 2 illustrates an exemplary diagrammatical representation of a transactional risk and return analysis system 28. Some or all of the transactional risk and return analysis system 28 may be implemented as computer readable media or programmed code stored and/or processed by the computing device 10. In one implementation, the transactional risk and return analysis system 28 includes or accesses one or both of a transaction database 30 and a market database 32. In such an implementation, the transaction database 30 includes a plurality of transactions and their respective attributes. Such transactions may include loans, leases, equity positions, and so forth. Each individual transaction is associated with various attributes that characterize or describe the transaction, including, but not limited to, the amount borrowed or at stake, the credit quality of the borrower, payment timetable, company profile, and so forth. The company profile may include information such as industry sector, location/country of business, third-party ratings of the company, and so forth. In this example, the market database 32 may include a plurality of market factors that describe the general market climate, and historical data regarding each market factor. Such market factors may include, but are not limited to, employment rate, economic or monetary policy, inflation rates, stock market trends, and so forth.

Data from the transaction database 30 and the market database 32 are generally used in creating one or more portfolio models 34. The various portfolio models 34 use the attributes by which each transaction and/or market condition may be characterized to describe various interrelationships between the holdings constituting a portfolio of loans or other financial instruments. Such interrelationships may be used to characterize risk and return characteristics for a holding of the portfolio, for a subset of holdings of the portfolio, or for the portfolio in general. Such analyses may, in one embodiment, be generally directed to a probability of default or loss of economic capital or income associated with each potential transaction and may, therefore, characterize various risk and return characteristics of a potential transaction. This information may tell the user how much money (either as an absolute amount or as a ratio) should be reserved in order to cover the expected loss of each transaction, what the risk of default on the loan is, what the risk of prepayment of the loan is, and so forth.

The portfolio model 34 may include certain data and/or algorithms that quantify various correlations between transaction attributes such as the company profile and market factors to determine a probability of default and/or economic capital. Additionally, the portfolio model 34 may quantify or assess the diversity of the transactions defining the portfolio, and respective predictions, by accounting for categorical attributes such as industry, location, and so forth. For example, different industries may respond differently to certain market factors, and therefore exhibit different correlations. As such, the portfolio models 34 may apply a distinct model to transactions having a certain categorical attribute and another distinct model to transactions having another categorical attribute. The method of categorizing the transactions and the number of models are subject to variability from embodiment to embodiment. As mentioned, in certain embodiments the portfolio model 34 calculates and outputs a risk prediction for each transaction in the transaction database 30, which may be on the magnitude of half a million transactions. The risk predictions determined by the portfolio model 34 may be derived using complex formulas and models that take into account a very large number of, if not all, attributes associated with each transaction within the portfolio as well as a large amount of market data, and predictive correlations. In one implementation, the portfolio model may operate using a Monte Carlo sampling scheme or other probabilistic approach to model one or both of risk and return for the various transactions within a portfolio. The generated information may be organized or represented by a table showing each transaction, its attributes, the output risk prediction, and other relevant data pertaining to the transaction. The portfolio model(s) 34 may correspond to particular markets of interest, such as a real estate model, a commercial model, and so forth.

Due to the number of records that may be associated with a portfolio model 34, the computational intensity employed in the statistical analysis of the various interrelationships between the different factors and characteristics tracked for each record, and the nature of the probabilistic modeling employed in generating the various risk and return characteristics for each record, it may not be feasible to employ the various portfolio model(s) in evaluating individual proposed transactions or additions to the portfolio. For example, executing a given portfolio model to evaluate a proposed transaction may take hours or even days of computational processing, and thus may not be feasible for use in evaluating a given transaction, much less a set of such potential transactions.

With this in mind, in the depicted implementation, outputs of the various portfolio models 34 (such as a set of disaggregated variables 35) may be used to generate and fit (block 36) a separate regression model 37, or other suitable statistical model, that is suitable for analysis of proposed transactions. In particular, a respective model generated and fit in this approach provides a computationally efficient and rapid mechanism for modeling one or more outputs of the one or more portfolio models 34. For example, this model 37 may, when provided with the corresponding modeled characteristics of a proposed transaction, generate outputs (such as risk and return characteristics) for the proposed transaction that correspond to the outputs that would have been generated by the portfolio model(s) 34 if the portfolio model 34 were used to evaluate the proposed transaction.

With the foregoing in mind, in one embodiment, the model fitting process 36 uses regression modeling (or other suitable linear or non-linear statistical modeling approaches) to generate a computationally efficient model 37 that uses a subset of relevant transaction characteristics or variables to predict or estimate the corresponding output of a portfolio model 34 of interest. For example, the generated model 37 may be capable of outputting a risk prediction for a proposed transaction that corresponds to what would be estimated using the portfolio model 34 itself. The estimated risk prediction may include elements such as probability of default, expected loss, economic capital, and so forth.

In one example, inputs to the model fitting process 36 include the outputs from the portfolio model 34, including the transaction attributes, market conditions, and risk prediction associated with each transaction in the transaction database 30, as well as raw transaction data directly from the transaction database 30. That is, the model fitting process 36 may receive both the inputs and corresponding outputs for the transactions associated with a given portfolio model 34. The model fitting process 36 generates a model 37 that provides results and outputs similar to those derived using the portfolio model 34, but without the computational complexity of the portfolio model 34.

In one implementation, the data produced from the portfolio model 34, such as a table listing each transaction, associated attributes and market conditions, and risk prediction, is subjected to regression modeling to formulate a simple relationship between a subset of the transaction attributes, market conditions, and the risk prediction as determined by the portfolio model 34. Such a relationship or collection of relationships may be consolidated to generate a regression model 37 that can be used as a risk prediction model. The risk prediction model may be an additive model exhibiting the estimated effects that certain transaction or market data have on the risk prediction. As part of the model generation and fitting process, the risk prediction model initially or iteratively generated may be applied to a sample of transactions from the transaction database 30 to obtain an estimated risk prediction for each of the sampled transactions. The estimated risk predictions can then be compared to the respective risk predictions produced by the portfolio model 34 to gauge effectiveness of the risk prediction model and/or to iteratively update or fit the risk prediction model. If the results are within a certain predetermined error threshold or tolerance, the risk prediction model may be accepted and saved.

The transactional risk and return analysis system 28 also includes a cash flow analysis model 38. In one implementation, the cash flow analysis model 38 uses data from the transaction database 30 and the market database 32 to perform a risk-breakeven calculation for a proposed transaction, for a set of transactions, or for a portfolio. The result is a risk-breakeven spread that helps determine what price to charge to compensate for risk associated with each proposed transaction or the aggregate risk of the entire portfolio.

As depicted in FIG. 2, in an implementation where a prospective transaction 40 is under consideration, the transactional risk and return analysis system 28 may include a transactional risk and return evaluation 42 component. In such an implementation, the prospective transaction 40 may include known attributes such as risk rating, company profile, transaction terms and conditions, loss rating, transition probability, market risk premium, capital costs, and so forth. The above attributes may be similar to or correspond to the attributes associated with transactions in the transaction database and/or may correspond to characteristics accepted as inputs by the model 37. In one implementation, the transactional risk and return evaluation 42 components utilizes inputs characterizing the prospective transaction 40, the model 37, and the risk-breakeven spread from the cash flow analysis model 38. In such an embodiment, the risk prediction model may model the prospective transaction data to derive a risk prediction. Additionally, the risk-breakeven spread from the cash-flow analysis model 38 may be integrated into the risk and return evaluation 42 to provide further insight.

As an output, the transaction risk and return evaluation 42 may generate a risk and return profile 44. The risk and return profile 44 includes various predicted risk and return data such as leverage, economic capital rating, expected loss, credit migration, risk-breakeven price, breakeven return on investment, risk-adjusted return on capital, and so forth. The transactional risk and return evaluation may also produce a transaction evaluation report 46. The transaction report 46 may include or summarize information derived from the transaction risk and return profile 44 or generated separately by the evaluation component 42. Such information provides insight into the prospective transaction that may aid the user in making transaction decision, such as underwriting decisions.

Referring again to FIG. 1, the transactional risk and return analysis system 28 as described above is generally realized as an executable computer program stored in or loaded into the memory 14 or storage device 16 of the computing device 10. The transaction database 30 and market database 32 may also be stored in the memory 14 or storage device 16. Alternatively, the databases 30, 32 may be stored on a network and accessed by the computing device 10 via the network device 18. Some data, such as prospective transaction data 40 may be input into the computing device 10 via the user interface, and generally stored for processing. Calculations, modeling, and model fitting are generally handled by the processor 12, which accesses the memory 14, storage device 16, or network device 18 to obtain the appropriate transaction and market data as well as executable instructions. The processor 12 computes accordingly and accesses or outputs the desired data for the portfolio model 34, the model fitting process 36 and model 37, the cash flow analysis model 38, and/or the transactional risk and return evaluation 42. Such outputs may be stored in the memory 14, storage device 16, or on a network. Certain outputs may also be outputted to the display 22 in a human readable format. Generally, the risk and return profile 44 and the transaction evaluation report 46 are outputted to the display 22 or to a printer via an I/O port 24.

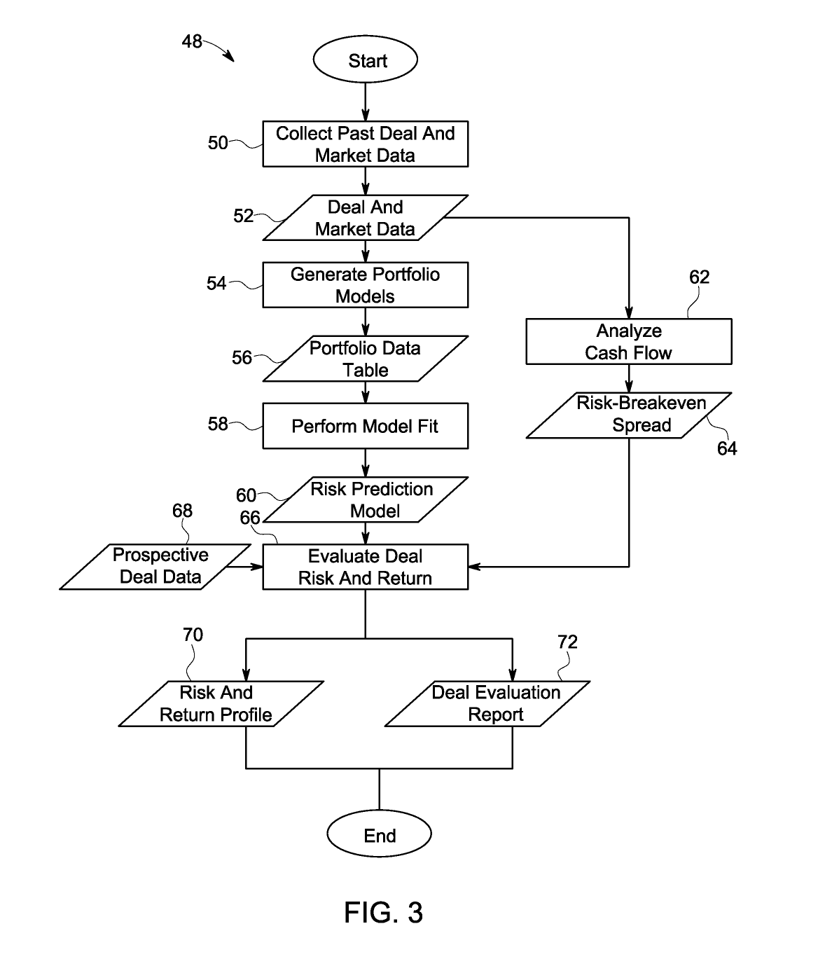

As discussed, the transactional risk and return analysis system may generally be expressed as an executable computer program 48. FIG. 3 illustrates a flow chart of one implementation of such a program 48. The program 48 starts by collecting data (block 50) regarding past transactions from the transaction database 30 as well as historical market data from the market database 35. This step results in transaction data and market data, as indicated by block 52. Subsequently, the transaction data and market data 52 are input into one or more portfolio models 34, as indicated by block 54. As previously discussed, this step may involve generating individual risk predictions for each transaction in the transaction database by assessing correlations and/or applying probabilistic approaches based on the transaction parameters. The output, in the depicted example, is a portfolio data table, as indicated by block 56, which lists every transaction processed by the portfolio model with its respective attributes, market condition, and associated risk prediction.

Next, a model fitting process, as indicated by activity block 58 is performed using the portfolio data table 56. In the model fitting process, the data from the portfolio data table 56 is subjected to regression modeling (or other suitable linear or non-linear statistical modeling) to generate one or more models 37 (e.g., regression equations) that utilize respective subsets of the characteristics within the portfolio data table to estimate one or more respective response characteristics (such as an amount or ratio of currency to hold in reserve, a default risk, a prepayment risk, a potential loss amount and so forth). As noted above, the one or more models 37 generated or fitted in this manner may be back-checked against historical transaction data and/or actual results of the portfolio models 34 being emulated. Such a model 37 or collection of models 37 may be used as a risk prediction model, as indicated by block 60. The risk prediction model 60 may be an additive or weighted model for producing an estimated risk prediction based on certain attributes of a transaction. As discussed herein, in certain embodiments the risk prediction model 60 is constructed to provide the same or a similar output as the portfolio model 34 would if provided the same transaction data. The risk prediction model may be saved within the program or elsewhere for future access.

As discussed herein, in certain embodiments, transaction and market data 52 may be input to respective analysis routines to analyze cash flow, as indicated by block 62. Such analysis may produce a risk-breakeven spread 64 or other cash flow metric. The risk-breakeven spread 64 and the risk prediction model 60, along with a prospective transaction 40 (and its associated attributes), may be used to evaluate risk and return for the prospective transaction 40, as indicated by block 66. The depicted program 48 then outputs a risk and return profile 70 and/or a transaction evaluation report 72, which may be displayed on the display 22 and/or stored.

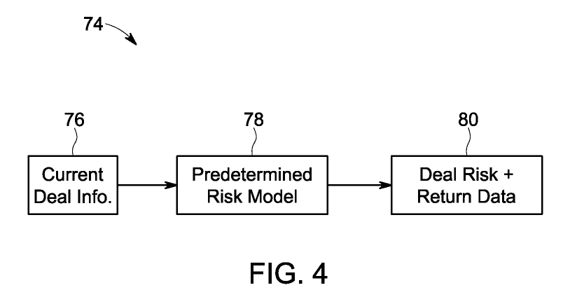

In certain embodiments, the transactional risk and return analysis system may repeat (i.e., iterate) certain steps without repeating the entire process, such as to fit or use the risk prediction model 60 to correspond to the respective portfolio model. Once a risk prediction model 60 is generated and saved, transactional risk and return analysis may be performed for various prospective transactions without performing steps 50 to 58. For example, FIG. 4 represents an embodiment 74 in which such a predetermined or pregenerated risk prediction model 78 is available. In one such embodiment, prospective transaction data 76 may be input into a risk prediction model 78 to obtain a risk and return profile and transaction evaluation report 80. That is, once the portfolio data table is produced by running the portfolio model once and the risk prediction model is obtained through regression modeling of the portfolio data table, the risk prediction model may be used to generate the risk prediction, risk and return profile, and transaction evaluation report for many prospective transactions without the need to perform portfolio modeling again or to generate a new risk prediction model corresponding to a portfolio model. As such, users may use the transaction risk and return analysis system to obtain risk and return data immediately upon entering a prospective transaction.

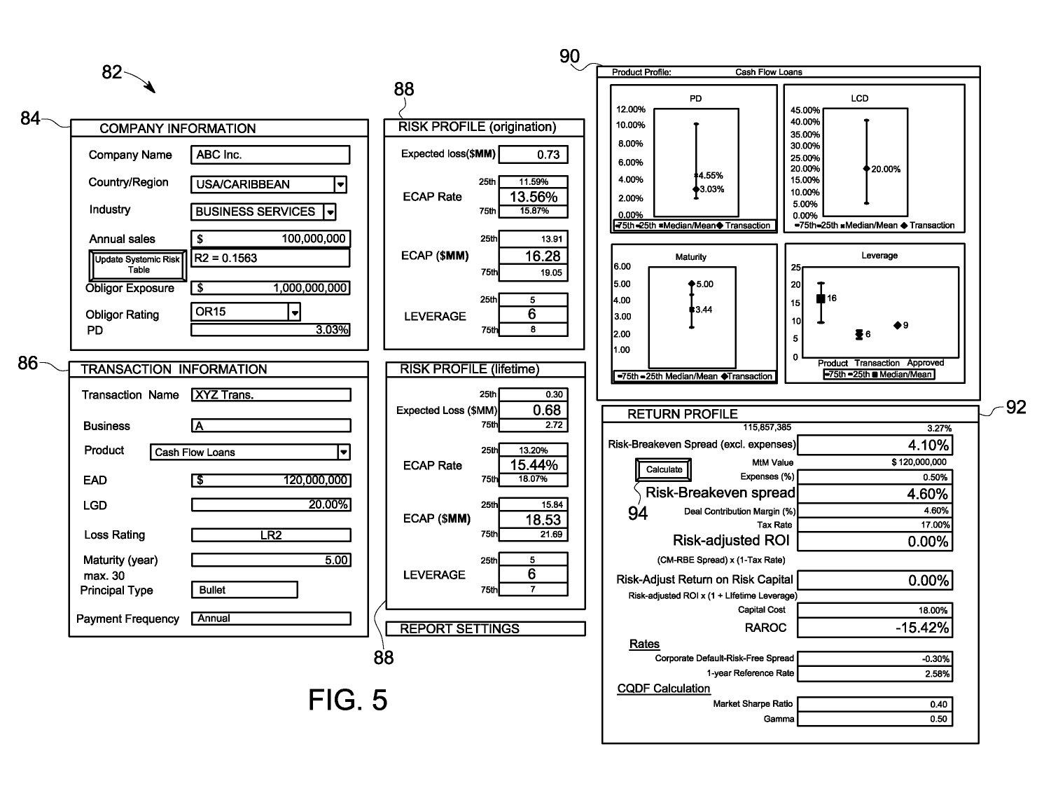

As previously discussed, the transactional risk and return analysis system is generally implemented as a computer program. FIG. 5 is a screenshot of an example of a graphical user interface (GUI) 82 of an embodiment of such a computer program. The present embodiment of the GUI includes a company information subscreen or window 84, a transaction information subscreen or window 86, risk profiles 88 for a prospective transaction, a product profile 90, a return profile 92, and a calculate button 94. The depicted GUI allows the user to input prospective transaction data into the company information subscreen or window 84 and the transaction information subscreen or window 86. Each of these subscreens 84, 86 includes one or more data entry fields or dropdown menus for the user to input the requested information. After the information is entered, the user may select the calculate button 94. After the calculate button is selected, the risk profiles 88, product profile 90 and return profile 92 are populated or updated with estimated transaction risk and return data using at least a model 37, as discussed herein, and the data entered into the respective subscreens 84, 86 as inputs to the model 37. This information is generated contemporaneously or near in time with the input of the prospective transaction data is inputted. This allows transaction underwriters to obtain timely and accurate risk and return information to assist them in making underwriting decisions.

Technical effects of the invention include providing a means for underwriters to obtain accurate risk and return characteristics in a timely manner, whereas previous means are generally lacking in accuracy or are time consuming. In one embodiment, the present invention employs regression model fitting to generate small scale, computationally light models that are representative of the large, computationally heavy portfolio models that often require hours or days to compute. As such, embodiments of the present invention allow users to quickly obtain risk and return characteristics which are comparable to those obtained from portfolio models.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A transactional risk and return analysis system, comprising:
a transaction database, wherein the transaction database comprises a plurality of transactions and a plurality of attributes associated with each transaction;
one or more portfolio models, wherein each portfolio model is configured to use at least the attributes from each transaction in the transaction database to estimate risk measures for each transaction;
a risk prediction model generated based on outputs of each of the respective portfolio models, wherein the risk prediction model is configured to estimate a risk measure for a prospective transaction;
a cash flow analyzer, wherein the cash flow analyzer is configured to use data from the transaction database and a market database to calculate a risk-breakeven spread; and
a transaction evaluator configured to calculate transactional risk and return data from the risk prediction model and the risk-breakeven spread, wherein the transaction database and the outputs of each of the respective portfolio models are stored in a memory device or a computing device separate than the memory device or the computing device on which the risk prediction model and the transaction evaluator are stored, wherein the risk prediction model is configured to be applied to the prospective transaction.

2. The transactional risk and return analysis system of claim 1, further comprising:
a market database, wherein the market database comprises a plurality of historical or current values of market indicators or macro economic indicators;
wherein each portfolio model is configured to use the market indicators or macro economic indicators from the market database in estimating risk measures for each transaction.

3. The transactional risk and return analysis system of claim 2, wherein a respective portfolio model comprises one or more correlations between certain attributes of the transactions from the transaction database, market indicators from the market database, and the estimated risk measure.

4. The transactional risk and return analysis system of claim 1, wherein the prospective transaction is inputted into the transaction evaluator to obtain a risk prediction for said prospective transaction.

5. The transactional risk and return analysis system of claim 1, wherein the one or more portfolio models comprises a plurality of models, each respective model corresponding to a different transaction category or risk measure, wherein an appropriate model is applied to a transaction within the corresponding transaction category and risk measure estimation.

6. The transactional risk and return analysis system of claim 1, wherein the outputs of a respective portfolio model comprise attributes of each transaction in the transaction database, one or more market conditions associated with each transaction, and the estimated risk of each transaction.

7. The transactional risk and return analysis system of claim 6 wherein the risk prediction model is generated using regression modeling on the outputs of the respective portfolio model.

8. The transactional risk and return analysis system of claim 1, wherein the risk prediction model is configured to take as input, the prospective transaction, and output an estimated risk prediction, the estimated risk prediction being comparable to the risk prediction that would have been estimated by the portfolio model.

9. The transactional risk and return analysis system of claim 1, wherein the risk prediction comprises one or both of an estimated reserve amount associated with each prospective transaction or a probability of default associated with each transaction.

10. The transactional risk and return analysis system of claim 1, wherein the risk prediction model is configured to calculate a risk prediction faster than the one or more portfolio models.

11. The transactional risk and return analysis system of claim 1, wherein the transactional risk and return analysis system is stored on a computing device as an executable computer program.

12. The transactional risk and return analysis system of claim 1, wherein the transaction evaluator is configured to output at least one of a transactional risk and return profile or a transaction evaluation report.

13. The transactional risk and return analysis system of claim 1, wherein the risk prediction model is an additive model which calculates a risk prediction associated with a certain transaction based on attributes associated with the transaction.

14. (canceled)

15. The transactional risk and return analysis system of claim 1, wherein the transaction evaluator is configured to output at least one of the transactional risk and return profile and the transaction evaluation report immediately after the prospective transaction is inputted.

16. A transactional risk and return analysis tool, comprising:
a risk prediction model fitted from a portfolio model through regression modeling, wherein the risk prediction model is configured to take as an input, a prospective transaction and its associated attributes, and calculate a risk prediction for the prospective transaction;
a cash flow analysis model configured to provide a risk-breakeven spread for the prospective transaction; and
a risk and return evaluator configured to receive the risk prediction model, the cash flow analysis model, and the prospective transaction and to output at least one of a transactional risk and return profile or a transaction evaluation report associated with the prospective transaction,
wherein the risk prediction model, the cash flow analysis model, and the risk and return evaluator are realized via a processor of a computing device.

17. A transactional risk and return analysis tool of claim 16, further comprising a graphical user interface (GUI), configured to allow a user to input the prospective transaction and its associated attributes.

18. The transactional risk and return analysis tool of claim 17, wherein the GUI is configured to display at least one of the transactional risk and return profile or the transaction evaluation report associated with the prospective transaction.

19. A transactional risk and return analysis method, comprising:
inputting a plurality of attributes of transactions from a transaction database into a portfolio model;
estimating a risk prediction for each transaction using the portfolio model, wherein the portfolio model outputs each transaction from the transaction database with its associated attributes and estimated risk prediction;
generating a regression model based on the output of the portfolio model;
generating one or more risk measures for a prospective transaction using the regression model;
generating a risk-breakeven spread for the proposed transaction using a cash flow model; and
evaluating a transactional risk and return based on the one or more risk measures and the risk-breakeven spread,
wherein such steps are performed by a processor of a computing device based on programmed instructions.

20. The transactional risk and return analysis method of claim 19, further comprising outputting, in a human readable format, at least one of a transactional risk and return profile or a transaction evaluation report based on the evaluation of the transactional risk and return.

21. The transactional risk and return analysis method of claim 19, wherein the one or more risk measure comprise a reserve amount, a reserve ratio, a risk of default, or a prepayment risk.

22. The transactional risk and return analysis method of claim 19, wherein market data from a market database is input into the portfolio model in addition to the plurality of attributes of transactions.
